(19) United States
(12) Patent Application Publication
(10) Pub. No.: US 2014/0289022 A1
(43) Pub. Date: Sep. 25, 2014

(54) TASK ASSISTANCE DEVICE, TASK ASSISTANCE SYSTEM, TASK ASSISTANCE METHOD, AND STORAGE MEDIUM WITH PROGRAM STORED THEREIN

(71) Applicant: NEC CORPORATION, Tokyo (JP)

(72) Inventors: Yuki Kamiya, Tokyo (JP); Takao Shime, Tokyo (JP); Hirohiko Ito, Tokyo (JP); Kazuo Kunieda, Tokyo (JP)

(73) Assignee: NEC CORPORATION, Minato-ku, Tokyo (JP)

(21) Appl. No.: 14/352,014

(22) PCT Filed: Sep. 28, 2012
(86) PCT No.: PCT/JP2012/075135

§ 371 Date: Apr. 15, 2014

(30) Foreign Application Priority Data
Oct. 18, 2011 (JP) 2011-228769

(51) Int. Cl. G06Q 10/06

(52) U.S. Cl. CPC G06Q 10/06398
USPC 705/7.42

(57) ABSTRACT

A basic behavior information acquirer (11) of a task assistance device (1) acquires basic behavior information that indicates behavior of a member. A task behavior information appender (12) appends, to the basic behavior information, task behavior information that indicates a pre-set classification of the behavior. A task flow calculator (13) calculates a task flow that interrelates the task behavior information based on attribute information of the basic behavior information to which the task behavior information is appended. An expected task flow acquirer (14) acquires an expected task flow that a member is supposed to perform. A task flow difference detector (15) detects difference between the task flow and the expected task flow. An outputter (71) outputs presentation information that indicates difference between the task flow and the expected task flow.

### TECHNICAL FIELD

The present invention relates to a task assistance device, a task assistance system, a task assistance method, and a storage medium with a program stored therein, which assist a task of a subject member.

### BACKGROUND ART

Recently, with spread of computer technology, content of a work task has been changing. Autor, Levy and Murnane abandoned a “high-skill” and “low-skill” dichotomy that was a major-stream in the 1990s, and classified task content into the following five classifications in terms of whether routine or non-routine, whether intellectual work or physical work, and the like:

Non-routine Analytic tasks,

Non-routine Interactive tasks,

Routine Cognitive tasks,

Routine Manual tasks, and

Non-routine Manual tasks.

While spread of computer technology has been substituting for Routine Manual tasks and Routine Cognitive tasks where predefined standards are required to be exactly achieved, and reducing labor demand thereof, Non-routine Analytic tasks where solving of an abstract problem is required under highly technical knowledge and Non-routine Interactive tasks where problem solving through interactive communication ability with a client is required are compensated, increasing labor demand thereof (refer to Non Patent Literature 1).

Further, in recent years, there has been an increasing demand for an interdisciplinary problem solving even for a problem within a single field. Therefore, even in Non-routine Analytic tasks, problem solving through highly-skilled interactive communication ability between members with highly technical knowledge is required.

In Non-routine Analytic tasks and Non-routine Interactive tasks where solving of an abstract problem is required, it is difficult for a manager who controls task states to set a clear guide in advance for task content of all subject members. Therefore, there may be a possibility that task activities in a project do not satisfy the manager's expectation, and as a result, a problem cannot be adequately solved. To prevent this, it is important that the manager can quickly check task states of a project within a limited time. It is also important that members who engage in problem-solving together can check a plan for carrying out tasks towards problem-solving with one another.

Patent Literature 1 discloses a sensor network system that grasps who and how much is committed to a created file based on sensor data. According to Patent Literature 1, who carried out what kind of task to given data, such as time taken for creating a file and meeting time relating to the file, can be grasped from task sensing data.

### CITATION LIST

### Patent Literature

Patent Literature 1: Unexamined Japanese Patent Application Kokai Publication No. 2009-211574.

### Non Patent Literature

Non Patent Literature 1: Toshie Ikenaga & Ryo Kambayashi (2009) “Long-term Trends in the Polarization of the Japanese Labor Market: Increase of non-routine tasks,” pp. 3-5.

### SUMMARY OF INVENTION

### Technical Problem

However, with technique of Patent Literature 1, it is not possible to know whether a task carried out to solve a problem is actually carried out in a way that a manager expects a member to do. The expected way means a task flow that the member is supposed to carry out, including whether a thorough research is conducted, whether members with different specialties are appropriately involved, and whether critical work is not left behind.

The present invention was accomplished in consideration of the above circumstances. The objective of the present invention is to provide a task assistance device, a task assistance system, a task assistance method, and a storage medium with a program stored therein, which allow to grasp whether behavior of a subject member is carried out in accordance with a task flow that is supposed to be performed.

### Solution to Problem

A task assistance device according to a first aspect of the present invention comprises: basic behavior information acquirer that acquires basic behavior information that indicates behavior of a subject member and includes attribute information associated with the behavior; task behavior information appender that appends task behavior information that indicates a pre-set behavior classification to the basic behavior information; task flow calculator that calculates a task flow that interrelates the task behavior information based on the attribute information included in the basic behavior information to which the task behavior information is appended; expected task flow acquirer that acquires an expected task flow that indicates a task flow that the member is supposed to perform; task flow difference detector that detects difference between the task flow calculated by the task flow calculator and the expected task flow acquired by the expected task flow acquirer; and outputter that outputs presentation information that indicates difference between the task flow and the expected task flow.

A task assistance system according to a second aspect of the present invention comprises: a behavior detection device that includes detector that detects behavior of a subject member; a task assistance device that includes basic behavior information acquirer that acquires basic behavior information that indicates behavior of the member and includes attribute information associated with the behavior from the behavior detection device, task behavior information appender that appends task behavior information that indicates a pre-set behavior classification to the basic behavior information, task flow calculator that calculates a task flow that interrelates the task behavior information based on the attribute information included in the basic behavior information to which the task behavior information is appended, expected task flow acquirer that acquires an expected task flow that indicates a task flow that the member is supposed to perform, and task flow difference detector that detects difference between the task flow calculated by the task flow calculator and the expected task flow acquired by the expected task flow acquirer; and a user terminal that includes outputter that outputs presentation information that indicates difference between the task flow and the expected task flow.

A task assistance method according to a third aspect of the present invention comprises: a detection step of detecting behavior of a subject member, carried out by a behavior detection device; a basic behavior information acquisition step of acquiring basic behavior information that indicates behavior of the member and includes attribute information associated with the behavior, from the behavior detection device, carried out by a task assistance device; a task behavior information appending step of appending task behavior information that indicates a pre-set behavior classification, to the basic behavior information; a task flow calculation step of calculating a task flow that interrelates the task behavior information based on the attribute information included in the basic behavior information to which the task behavior information is appended; an expected task flow acquisition step of acquiring an expected task flow that indicates a task flow that the member is supposed to perform; a task flow difference detection step of detecting difference between the task flow calculated in the task flow calculation step and the expected task flow acquired in the expected task flow acquisition step; and an output step of outputting presentation information that indicates difference between the task flow and the expected task flow that is detected in the task flow difference detection step.

A program stored in a storage medium according to a fourth aspect of the invention causes a computer to function as: basic behavior information acquirer that acquires basic behavior information that indicates behavior of a subject member and includes attribute information associated with the behavior; task behavior information appender that appends task behavior information that indicates a pre-set behavior classification, to the basic behavior information; task flow calculator that calculates a task flow that interrelates the task behavior information based on the attribute information included in the basic behavior information to which the task behavior information is appended; expected task flow acquirer that acquires an expected task flow that indicates a task flow that the member is supposed to perform; task flow difference detector that detects difference between the task flow calculated by the task flow calculator and the expected task flow acquired by the expected task flow acquirer; and outputter that outputs presentation information that indicates difference between the task flow and the expected task flow.

### Advantageous Effects of Invention

The present invention makes it possible to grasp whether behavior of a subject member is carried out in accordance with a task flow that is supposed to be performed.

### BRIEF DESCRIPTION OF DRAWINGS

FIG. 1 is a block diagram showing a configuration example of a task assistance system according to a first embodiment of the present invention;

FIG. 2 is a diagram illustrating an example of basic behavior information;

FIG. 3 is a diagram showing an example of a correspondence table of task behavior information and basic behavior information;

FIG. 4 is a diagram illustrating an example of basic behavior information with appended task behavior information;

FIG. 5 is a diagram illustrating an example of a task flow;

FIG. 6 is a diagram illustrating a method of detecting difference between an expected task flow and the task flow;

FIG. 7 is a diagram illustrating an example of presentation information that indicates difference between the expected task flow and the task flow of a single member;

FIG. 8 is a diagram illustrating an example of presentation information that indicates difference between the expected task flow and the task flow of a plurality of members;

FIG. 9 is a flowchart showing an example of a task assistance operation according to the first embodiment;

FIG. 10 is a block diagram showing a configuration example of a task assistance system according to a second embodiment of the present invention;

FIG. 11 is a flowchart showing an example of a task assistance operation according to the second embodiment;

FIG. 12 is a block diagram showing a configuration example of a task assistance system according to a modified example of the present invention; and

FIG. 13 is a block diagram showing a hardware configuration example of a task assistance device according to the embodiments.

### DESCRIPTION OF EMBODIMENTS

In the present invention, whether or not a subject member is carrying out a task according to a task flow that is supposed to be performed, is presented to a user who needs to grasp a task state.

In the following, a task assistance system according to the embodiments of the present invention will be described in detail with reference to the drawings.

### First Embodiment

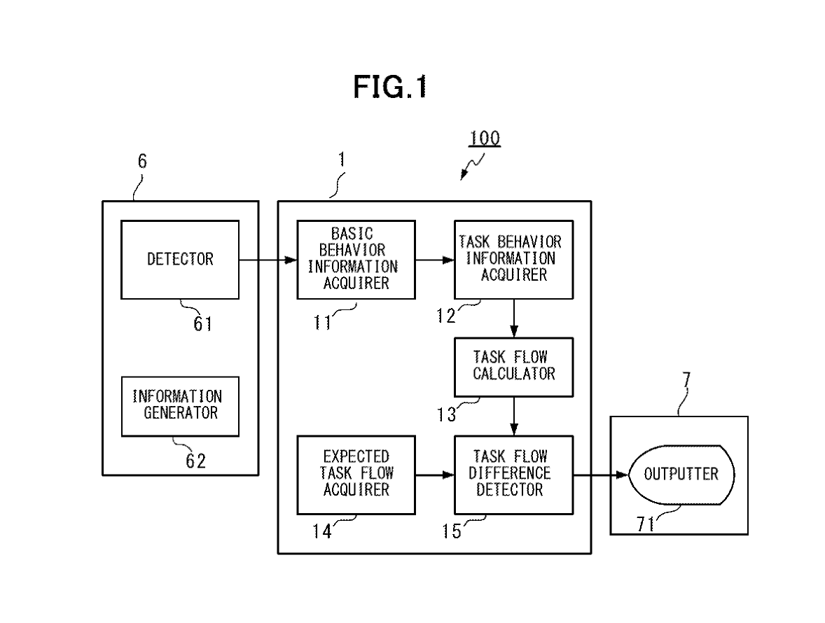

First, a task assistance system according to a first embodiment of the present invention will be described. FIG. 1 is a block diagram showing a configuration example of the task assistance system according to the first embodiment of the present invention. The task assistance system 100 of the first embodiment comprises: a task assistance device 1; a behavior detection device 6; and a user terminal 7. The task assistance device 1 is connected intercommunicably with the behavior detection device 6 and the user terminal 7 via a network.

It is noted that in this embodiment, description is made in terms of an example where the behavior detection device 6 and the user terminal 7 are configured separately from the task assistance device 1, but the behavior detection device 6 and/or the user terminal 7 may be integrally configured with the task assistance device 1.

Further, in FIG. 1, the behavior detection device 6 and the user terminal 7 are illustrated respectively as single units as representatives, although there are cases where two or more units are connected to the network.

Each component that configures the task assistance system 100 will be described specifically in the following.

[Behavior Detection Device 6]

The behavior detection device 6 includes a detector 61 that detects behavior of a subject member and an information generator 62 that generates basic behavior information based on a detection result by the detector 61 and transmits the generated basic behavior information to the task assistance device 1.

As is described above, the detector 61 of the behavior detection device 6 carries out a detection step of detecting behavior of the subject member. The detector 61 is configured by, for example, an inputter of a PC such as a keyboard and a mouse, or a RF tag reader. For example, to detect a task that a member performed using a Personal Computer (PC), the inputter of the PC functions as the detector 61. Furthermore, to detect behavior such as entering and leaving a room based on a position of the member using an RF tag, the RF tag reader functions as the detector 61.

It is noted that other methods of detecting a position of a member include a method using a Global Positioning System (GPS) and a method of calculating a position based on field intensity that is received by a mobile communication base station. Further, position information of a person or an article may be acquired by a detection method using a camera that is installed in advance in an office, a warehouse, and the like, and using an image recognition technique and the like.

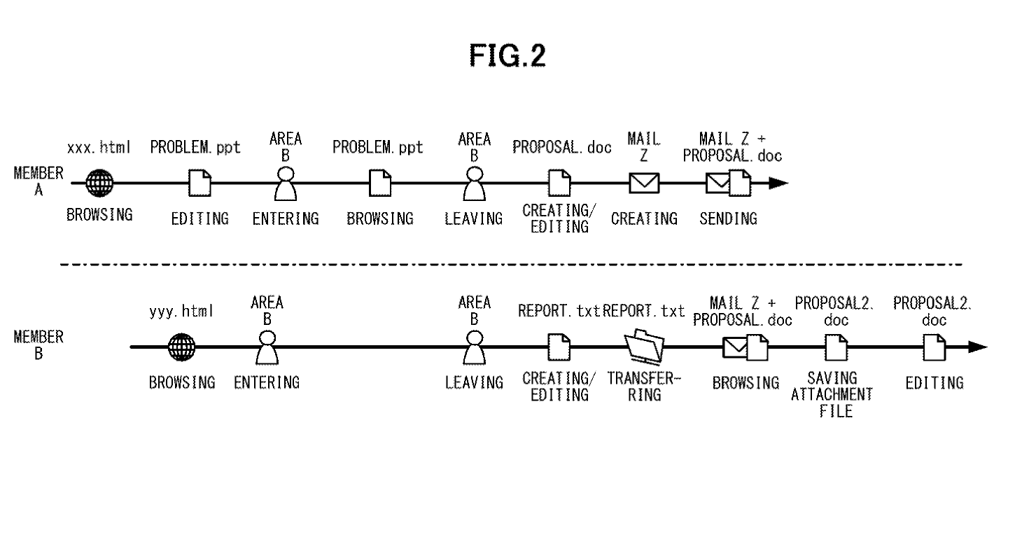

As is described above, the information generator 62 generates basic behavior information. As is shown in FIG. 2, the basic behavior information, for example, comprises information indicating behavior of a member such as creating a file, browsing a Web site, sending and receiving a mail, saving an attachment file, participating in a meeting (entering and leaving a predetermined area). Further, while attribute information is omitted in FIG. 2, the basic behavior information includes the attribute information associated with the behavior other than information that indicates the behavior of a member. The attribute information is, for example, information such as a file creator, a file browser, file creation time and date, a mail sender, a mail receiver, mail sending time and date, a meeting participant, and meeting time and date.

In the following, a configuration of the basic behavior information will be described further in detail. It is noted that the attribute information is omitted in FIG. 2.

[Basic Behavior Information]

In FIG. 2, basic behavior of members is displayed separately for respective objects of behavior using icons indicating contents of the basic behavior. The icons are arranged in a time series along a direction of arrows in FIG. 2. Lateral positions of the icons indicate time when the detector 61 detects behavior of a subject member. By referring to the basic behavior information, time after a member performs a certain work until the member moves to the next work is calculated.

In addition, contents of the basic behavior (browsing, editing, and the like) are displayed below the icons. Further, the objects of behavior (part of the attribute information, such as a URL and a file name) are displayed above the icons. In this description, for the convenience of description, ‘Web site’ is abbreviated to ‘site;’ ‘electronic file’ to ‘file,’ and ‘E-mail’ to ‘mail.’.

In particular, the contents of the basic behavior information will be described further in detail with reference to FIG. 2. The example shown in FIG. 2 shows behavior of a member A and a member B.

As is shown in FIG. 2, the member A browses a site “xxx.html” and edits a file “problem.ppt.” Thereafter, the member A enters an area B, browses the file “problem.ppt,” and leaves the area B. Then, the member A creates/edits a file “proposal.doc” and creates a mail Z. Finally, the member A attaches the file “proposal.doc” to the mail Z and transmits the mail to the member B.

Meanwhile, the member B browses a site “yyy.html” and enters an area B. Thereafter, the member B leaves the area B, and creates/edits a file “report.txt.” Then, the member B transfers the file “report.txt” to a server. Then, the member B browses the mail Z received from the member A and the attachment file “proposal.doc,” and saves the attachment file “proposal.doc” as “proposal 2.doc.” Finally, the member B edits the file “proposal 2.doc.”

In this way, by including information relating to behavior of the member A and behavior of the member B in one set of basic behavior information, a state of work handed over from the member A to the member B can be grasped. For example, time elapsed from when the member A creates the mail Z until when the member B browses the mail Z can be grasped. Therefore, a state of progress of a group in case that a plurality of members work in the group can be grasped.

It is noted that, although in this embodiment, processing of detecting behavior of a member, creating basic behavior information, transmitting the basic behavior information, and the like are carried out by different components respectively, it is not limited thereto, and the processing may be carried out, for example, only by the detector 61 without limitation.

[Task Assistance Device 1]

The task assistance device 1 includes a basic behavior information acquirer 11, a task behavior information appender 12, a task flow calculator 13, an expected task flow acquirer 14, and a task flow difference detector 15.

[Basic Behavior Information Acquirer 11]

The basic behavior information acquirer 11 carries out a basic behavior information acquisition step of acquiring basic behavior information that indicates behavior of a subject member and includes attribute information associated with the behavior from the behavior detection device 6. Further, the basic behavior information acquirer 11 carries out a step of transmitting the acquired basic behavior information to the task behavior information appender 12.

[Task Behavior Information Appender 12]

The task behavior information appender 12 carries out a task behavior information appending step of appending task behavior information that indicates a pre-set behavior classification to basic behavior information received from the basic behavior information acquirer 11. Also, the task behavior information appender 12 carries out a step of transmitting the basic behavior information with the appended task behavior information to the task flow calculator 13.

In the following, the “task behavior information appending step” that the task behavior information appender 12 carries out will be described further in detail.

[Task Behavior Information Appending Step]

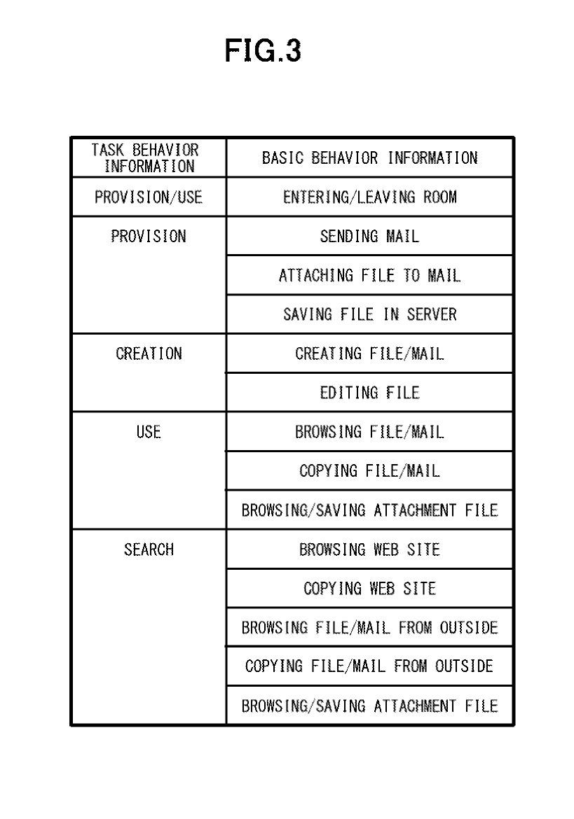

The task behavior information appender 12 stores a correspondence table (refer to FIG. 3) that correlates task behavior information that indicates a pre-set behavior classification and basic behavior information. The task behavior information appender 12, upon receiving the basic behavior information, refers to the correspondence table and appends the task behavior information to the basic behavior information. It is noted that attribute information included in the basic behavior information is not shown in FIG. 3

For example, upon receiving basic behavior information that indicates entering and leaving a certain area such as a meeting room, the task behavior information appender 12 refers to the correspondence table shown in FIG. 3 and determines that the member has participated in a meeting. Then, the task behavior information appender 12 appends task behavior information of “provision/use” to the basic behavior information indicating entering and leaving a room.

Similarly, upon receiving basic behavior information that indicates sending a mail, attaching a file to a mail, and saving a file to a server, the task behavior information appender 12 determines that the member has provided data for other members. Then, the task behavior information appender 12 appends task behavior information of “provision” to the basic behavior information that indicates sending a mail, attaching a file to a mail, and saving a file to a server.

In addition, upon receiving basic behavior information that indicates creating a file/mail and editing a file, the task behavior information appender 12 determines that the member has created new data. Then, the task behavior information appender 12 appends task behavior information of “creation” to the basic behavior information that indicates creating a file/mail and editing a file.

Further, upon receiving basic behavior information that indicates browsing a file/mail, copying a file/mail, and browsing/saving an attachment file, the task behavior information appender 12 determines that the member has used data provided by other members. Then, the task behavior information appender 12 appends task behavior information of “use” to the basic behavior information that indicates browsing a file/mail, copying a file/mail, and browsing/saving an attachment file.

Moreover, upon receiving basic behavior information that indicates browsing a Web site, copying a Web site, browsing a file/mail from the outside, copying a file/mail from the outside, and browsing/saving an attachment file from the outside, the task behavior information appender 12 determines that the member has used outside data. Then, the task behavior information appender 12 appends task behavior information of “search” to the basic behavior information that indicates browsing a Web site, copying a Web site, browsing a file/mail from the outside, copying a file/mail from the outside, and browsing/saving an attachment file from the outside. It is noted that this correspondence table is only an example and is not limited thereto.

It is noted that in this embodiment, the task behavior information appender 12 stores a correspondence table, but it is not limited thereto. For example, the table may be stored in an external memory. In such a case, the task behavior information appender 12 refers to the correspondence table stored in the external memory, and appends task behavior information to basic behavior information.

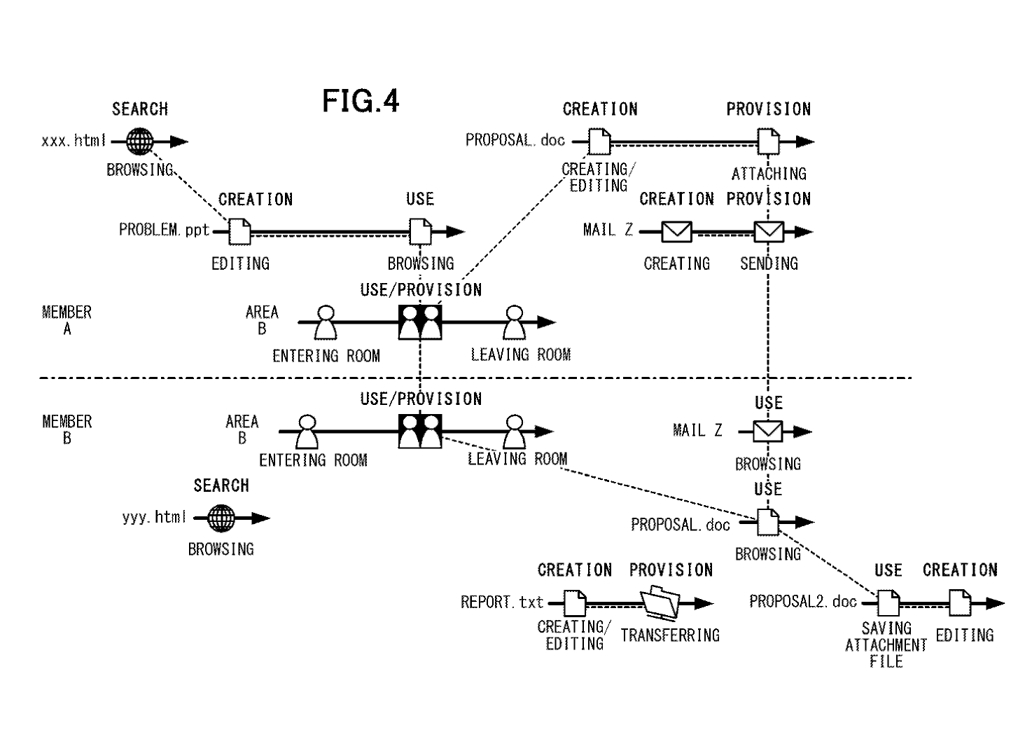

By the above-described “task behavior information appending step,” task behavior information is appended to basic behavior information (refer to FIG. 2) that is received from the basic behavior information acquirer 11 (refer to FIG. 4). In FIG. 4, task behavior information that is appended to basic behavior information is shown above icons that indicate contents of the basic behavior information.

In particular, task behavior information of “search” is appended to browsing a site “xxx.html” that a member A performed. Similarly, task behavior information of “creation” is appended to editing a file “problem.ppt.” Further, task behavior information of “use/provision” is appended to entering an area B, browsing the file “problem.ppt,” and leaving the area B. Further, task behavior information of “creation” is appended to creating/editing a file “proposal.doc.” Further, task behavior information of “creation” is appended to creating a mail Z. Further, task behavior information of “provision” is appended to attaching the file “proposal.doc” to the mail Z and transmitting of the mail Z to a member B.

Meanwhile, task behavior information of “search” is appended to browsing a site “yyy.html” that the member B performed. Similarly, task behavior information of “use/provision” is appended to entering the area B and leaving the area B. Further, task behavior information of “creation” is appended to creating/editing a file “report.txt.” Further, task behavior information of “provision” is appended to transferring the file “report.txt” to a server. Further, task behavior information of “use” is appended to receiving the mail Z from the member A and browsing the attachment file “proposal.doc” respectively. Further, task behavior information of “use” is appended to saving the attachment file “proposal.doc” as “proposal2.doc.” Further, task behavior information of “creation” is appended to editing the file “proposal2.doc.”

[Task Flow Calculator 13]

The task flow calculator 13 carries out a task flow calculation step of calculating a task flow that interrelates pieces of task behavior information based on attribute information included in basic behavior information to which the task behavior information is appended. Further, the task flow calculator 13 carries out a step of transmitting the calculated task flow to the task flow difference detector 15.

In the following, the “task flow calculation step” that the task flow calculator 13 carries out will be described further in detail.

[Task Flow Calculation Step]

The task flow calculation step that the task flow calculator 13 carries out comprises a detection step of detecting relevance among basic behavior information based on attribute information, and a definition step of defining, as a task flow, a series of basic behavior information, relevance of which is detected by the detection processing.

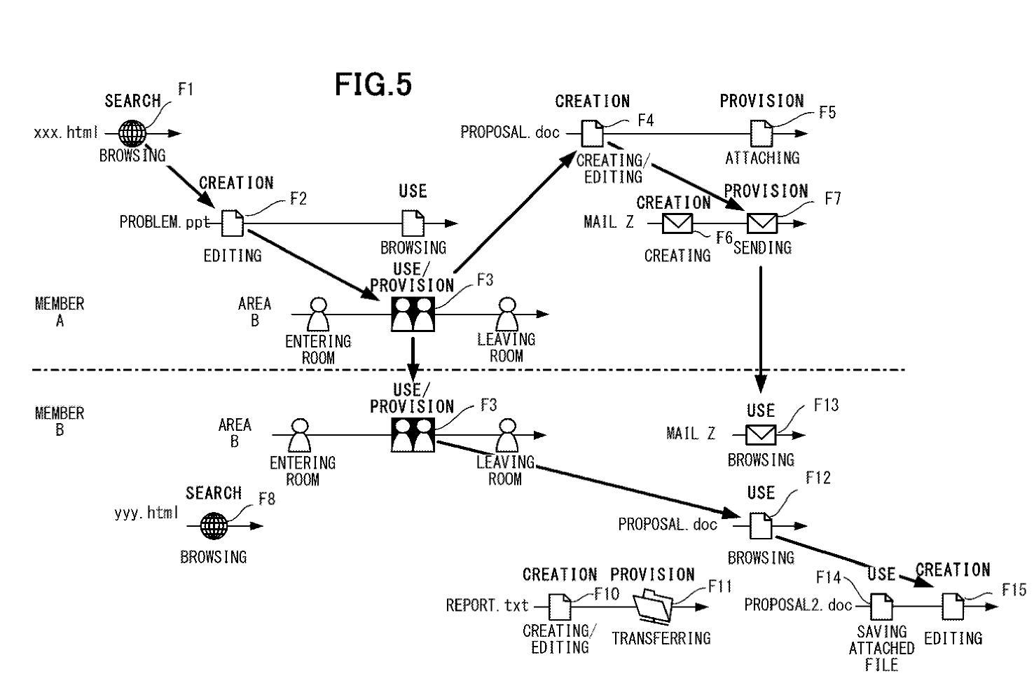

As is shown in FIG. 5, in the detection step, the task flow calculator 13 detects relevance among the basic behavior information based on the attribute information. FIG. 5 is a diagram illustrating an example of a task flow. In the example, similar to FIG. 4, icons that indicate contents of basic behavior are displayed separately by site, file, area, and the like, that are objects of behavior.

In particular, in the detection step, the task flow calculator 13 detects relevance among the basic behavior information, for example, based on attribute information such as a file name, a file creator, and file creation time and date. For example, the task flow calculator 13 interrelates pieces of the basic behavior information that match with any one of the file name, file creator, or file creation time and date in common.

In the example shown in FIG. 5, as a file browser of basic behavior information F1 and a file creator of basic behavior information F2 are “member A” and are the same, the task flow calculator 13 detects relevance between the basic behavior information F1 and the basic behavior information F2. Similarly, as a file name of the basic behavior information F2 and a file name of basic behavior information F3 are “problem.ppt” and are the same, the task flow calculator 13 detects relevance between the basic behavior information F2 and the basic behavior information F3. Further, as a file browser of the basic behavior information F3 and a file creator of basic behavior information F4 are “member A” and are the same, the task flow calculator 13 detects relevance between the basic behavior information F3 and the basic behavior information F4.

Further, as a file name of the basic behavior information F4 and a file name of basic behavior information F7 are “proposal.doc” and are the same, the task flow calculator 13 detects relevance between the basic behavior information F4 and the basic behavior information F7.

Next, in the definition step, the task flow calculator 13 defines a series of basic behavior information that are interrelated in the above-described detection processing as a task flow. That is, the task flow calculator 13 calculates a series of basic behavior information that starts from predetermined basic behavior information as a task flow. For example, if the above-described predetermined basic behavior information is “browsing a Web site,” as is shown in FIG. 5, the task flow calculator 13 calculates a series of basic behavior information that starts from “browsing a Web site” as a task flow. In this way, the task flow calculator 13 calculates, for example, a first task flow: “search (F1)”→“creation (F2)”→“use/provision (F3)”→“creation (F4)”→“provision (F7),” and a second task flow: “search (F1)”→“creation (F2)”→“use/provision (F3)”→“use (F12)”→“creation (F15).”

It is noted that, in the example of FIG. 5, when interrelating the basic behavior information, if attaching a file to a mail (F5) occurs after creating the file (F4), task information “creation” of creating the file (F4) and task information “provision” of sending a mail (F7) to which the file is attached, are interrelated. Further, if, after browsing an attachment file (F12), the attachment file is saved (F14) and the saved file is edited (F15), task information “use” of browsing the attachment file (F12), and task information “creation” of editing the saved file (F15), are interrelated. The task flow calculator 13 may calculate a task flow in accordance with a prescribed rule, or calculate a task flow using relevance of the basic behavior information as is.

Other rules include, such as the following. For example, when file names of attribute information are the same, it is determined that there is relevance. Further, even if the file names are different, yet file creators and file creation time and date are the same, it is determined that there is relevance by regarding that the files were saved with different names. Further, if browsing a site and creating a file are performed at the same time or within predetermined time, it is determined that there is relevance between basic behavior information indicating browsing the site and basic behavior information indicating creating the file. In this way, the task flow calculator 13 can interrelate basic behavior information based on a rule that is made in consideration of changes of file saving locations and file names. In addition, the task flow calculator 13 can interrelate basic behavior among different attributes based on acquisition time. It is noted that the above-described interrelation method is an example, and is not limited thereto.

It is noted that in the example shown in FIG. 4, relevance among basic behavior information is indicated by dashed lines.

It is noted that the task flow calculator 13 may include a timer function that times a timing of task flow calculation. If the task flow calculator 13 includes the timer function, task flow calculation can be performed at a predetermined timing. The predetermined timing is, for example, any one of the time when a predetermined term passes, when a predetermined number of pieces of basic behavior information are acquired, or when there is a presentation designation of a task state from the outside.

[Expected Task Flow Acquirer 14]

The expected task flow acquirer 14 carries out an expected task flow acquisition step of acquiring an expected task flow. Further, the expected task flow acquirer 14 carries out a step of transmitting the acquired expected task flow to the task flow difference detector 15. The expected task flow is a task flow that a user expects a member to perform and that the member is supposed to carry out.

In the following, “expected task flow acquisition step” that the expected task flow acquirer 14 carries out will be described further in detail.

[Expected Task Flow Acquisition Step]

The expected task flow acquirer 14 comprises a storage and an inputter that are not shown in the drawings. The storage stores an expected task flow in advance, and the expected task flow acquirer 14 accesses the storage and acquires the expected task flow.

Further, the inputter is configured to be able to rewrite the expected task flow that is stored in the storage when a user directly inputs through the inputter. The inputter is configured by, for example, a keyboard, a mouse, and the like of a PC.

The expected task flow acquirer 14 acquirers a rewritten expected task flow when rewrite processing to the expected task flow occurs by input operation of a user. Rewriting the expected task flow occurs, for example, when a user selects a task flow that the user expects a member to perform from pre-populated options.

It is noted that input operation for rewriting an expected task flow may be performed by an inputter of the user terminal 7, as will be described later. In such a case, a rewritten expected task flow that is rewritten by the inputter of the user terminal 7 is stored in the storage of the expected task flow acquirer 14. Then, the expected task flow acquirer 14 refers to the rewritten expected task flow stored in the storage and acquires the expected task flow.

It is noted that the expected task behavior acquirer 14 carries out acquisition of the expected task flow concurrently with the task flow calculation step of the above-described task flow calculator 13.

[Task Flow Difference Detector 15]

The task flow difference detector 15 carries out a task flow difference detection step of comparing a task flow calculated by the task flow calculator 13 and an expected task flow acquired by the expected task flow acquirer 14, and detecting difference between the task flow and the expected task flow. Moreover, the task flow difference detector 15 carries out a transmission step of generating presentation information that indicates the detected difference between the task flow and the expected task flow, and transmitting the generated presentation information to the user terminal 7.

In the following, the “task flow difference detection step” and the “transmission step” that the task flow difference detector 15 carries out will be described in detail.

[Task Flow Difference Detection Step]

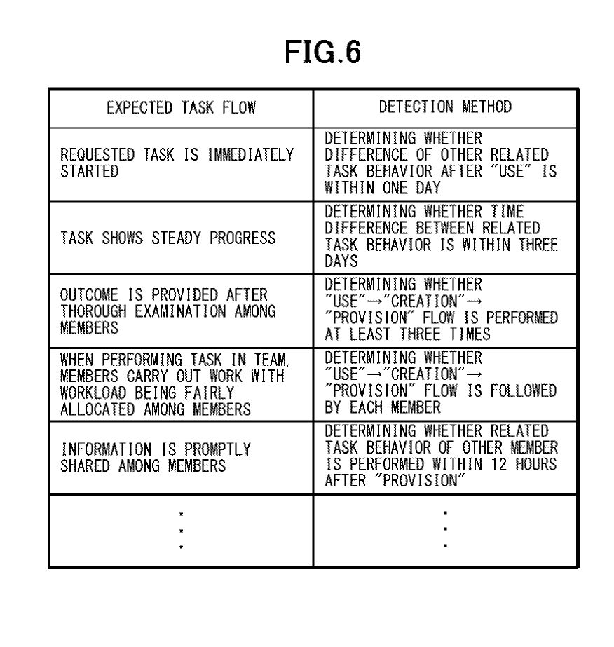

The task flow difference detector 15, specifically, refers to a correspondence table shown in FIG. 6 and detects difference between a task flow and an expected task flow. The correspondence table is, for example, stored in the task flow difference detector 15.

The correspondence table correlates an expected task flow to a detection method of detecting difference from a task flow. The example shown in FIG. 6 shows a case where expected task flows are “requested task is immediately started,” “task shows steady progress” “outcome is provided after thorough examination among members,” “when performing task in team, members carry out work with workload being fairly allocated among members,” and “information is promptly shared among members.”

The task flow difference detector 15 detects difference between a task flow and an expected task flow by determining whether or not the task flow matches with content of a detection method.

For example, to detect difference between an expected task flow of “requested task is immediately started” which is shown in FIG. 6 and a task flow that a member actually carried out, the task flow difference detector 15 determines whether or not the task flow of the member matches with content of a detection method corresponding to the expected task flow of “requested task is immediately started.” That is, the task flow difference detector 15 determines whether or not a difference of other related task behavior after “use” is within one day.

Then, when the difference of the other related task behavior after “use” is within one day in the task flow received from the task flow calculator 13, the task flow difference detector 15 determines that the content of the detection method matches with the expected task flow. In such a case, the task flow difference detector 15 does not detect difference between the expected task flow and the task flow.

On the other hand, if the difference of the other related task behavior after “use” is not within one day, the task flow difference detector 15 determines that the content of the detection method does not match with the expected task flow. In such a case, the task flow difference detector 15 detects difference between the expected task flow and the task flow.

Similarly, detection of difference between an expected task flow of “task shows steady progress” and a task flow is performed by determining whether or not a time difference between related tasks is within three days.

Further, detection of difference between an expected task flow of “outcome is provided after thorough examination among members” and a task flow is performed by determining whether or not a flow of “use” “creation” “provision” is performed three times or more.

Further, detection of difference between an expected task flow of “when performing task in team, members carry out work with workload being fairly allocated among members” and a task flow is performed by determining whether or not a flow of “use” “creation” “provision” is followed by each member.

Further, detection of difference between an expected task flow of “information is promptly shared among members” and a task flow is performed by determining whether or not related task behavior of other members is within 12 hours after “provision.”

[Transmission Step]

Moreover, the task flow difference detector 15, together with generating presentation information indicating the difference detected based on the above-described detection result, transmits the generated presentation information to the user terminal 7.

[User Terminal 7]

The user terminal 7 includes an outputter 71 that outputs presentation information and presents a task state of a member to a user. The outputter 71 carries out an output step of outputting the presentation information received from the task flow difference detector 15.

The outputter 71 is configured by a screen that displays presentation information received from the task assistance device 1, a speaker that outputs sounds, and the like. The outputter 71 outputs the presentation information received from the task flow difference detector 15. In this way, a user can check the presentation information so as to grasp a task state of each member.

In the following, the “output step” that the outputter 71 carries out will be described further in detail. It is noted that the following descriptions of the output step will be divided to a case where there is one subject member and a case where there are a plurality of subject members.

[Case where there is One Subject Member]

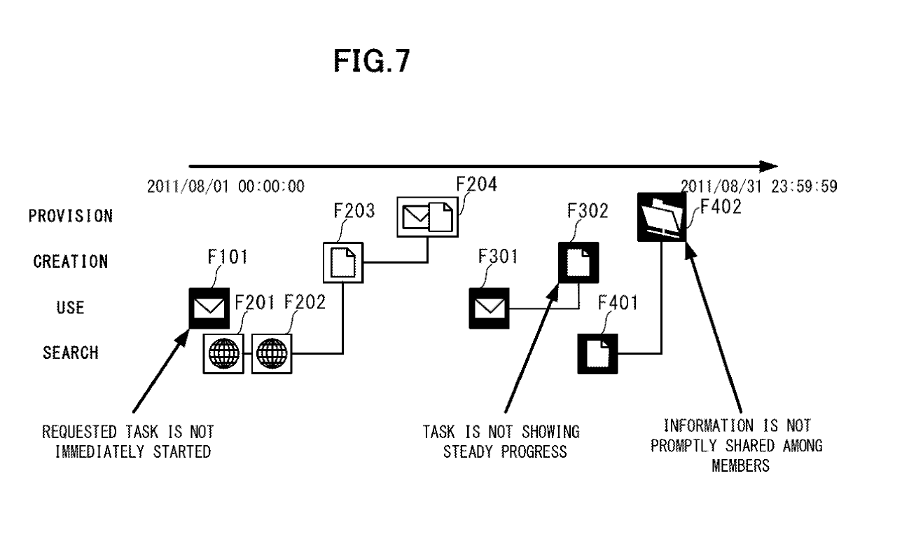

An example shown in FIG. 7 presents presentation information relating to a task flow of a given member in August 2011. As is shown in FIG. 7, the presentation information displayed by the outputter 71 includes all task flows relating to the member. For example, in FIG. 7, a first task flow (comprising basic behavior information F101), a second task flow (comprising basic behavior information F201, F202, F203, F204), a third task flow (comprising basic behavior information F301, F302), and a fourth task flow (basic behavior information F401, F402) are displayed.

Further, each basic behavior information F that configures the first to fourth task flows is classified and displayed as task behavior information of “provision,” “creation,” “use,” and “search,” respectively. For example, the basic behavior information F101 that configures the first task flow is classified as the task behavior information of “use.”

The presentation information output by the outputter 71 displays a background color of an icon being different from the expected task flow (low degree of achievement) in black and a background color of an icon matching with the expected task flow (high degree of achievement) in white. In this way, tasks that are smoothly progressing and tasks with some problems can be easily distinguished and grasped in the task flow of the member. It is noted that portions different from the expected task flow and portions matching with the expected task flow are not limited to difference of background colors of icons, but for example, the icons themselves may be color-coded, or the icons of the portions different from the expected task flow may flash.

In this way, by visually outputting the presentation information, a progress state or a degree of achievement of tasks of which a subject member is in charge can be grasped.

Further, as all task flows of which the member is in charge can be displayed, if a certain task shows no progress, whether or not the reason is an excessive task amount can be analyzed.

For example, as backgrounds of icons of the basic behavior information relating to the task flows F3 and F4 are all black, the task amount can be analyzed as excessive after the basic behavior information F301. Thus, the task progress can be expedited by succeeding tasks relating to the basic behavior information F301 and F302 and tasks relating to the basic behavior information F401 and F402 to the other members.

Further, by displaying with classification by task behavior information, whether or not there is progress can be analyzed. For example, as icons of the basic behavior information S101 and S301 of which task behavior information is “use” have black background color, the member is analyzed as performing poorly for tasks relating to “use.” Thus, the task operation can be improved by focusing on giving guidance on tasks relating to “use.”

By displaying such presentation information on the user terminal 7, a user can grasp portions different from the expected task flow and check a task state. Further, specifically, as is shown in FIG. 7, a fact that there is difference from the expected task flow, that is, a message indicating a task state, can be displayed in the presentation information. For example, in FIG. 7, a message “requested task is not immediately started” is displayed at a portion where a difference of other related task behavior after “use” of a mail is one day or more. Moreover, a message “task is not showing steady progress” is displayed at a portion that takes three days or more after “creation” of a file. Further, a message “information is not promptly shared among members” is displayed at a portion where a related task behavior of other member is not within 12 hours after “provision” of a file.

As in FIG. 7, using icons that signify contents of basic behavior such as a mail, a file, and a site, helps a user's understanding. Further, messages for indicating task states are not limited to the negative forms of sentences of the expected task patterns shown in FIG. 6, but may be generated to be more specific messages based on the basic behavior information, such as “mail is read but not yet moved to behavior,” “created file is left as is,” and “shared file is not used.”

[Case where there are a Plurality of Subject Members]

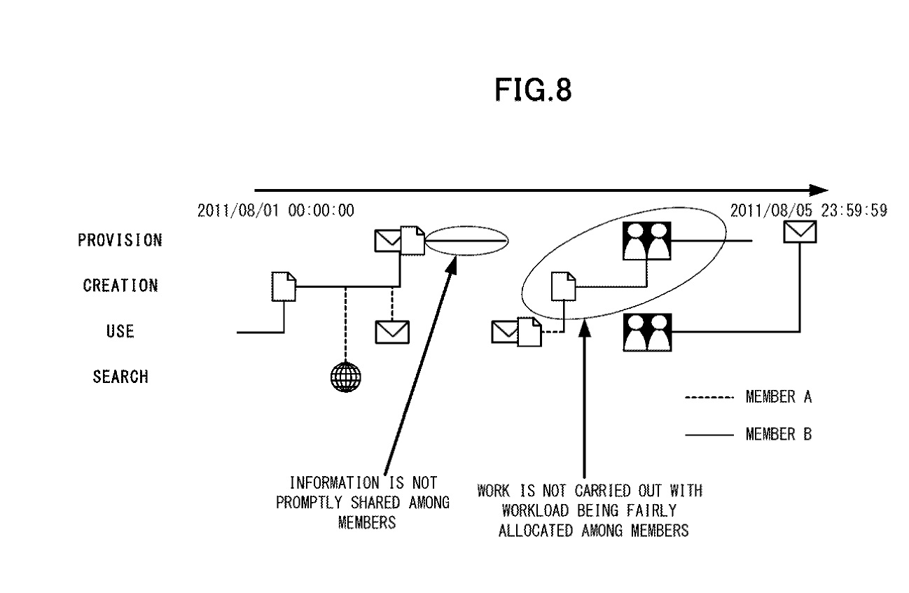

FIG. 8 is a diagram illustrating an example of presentation information that indicates difference between an expected task flow and a task flow of a plurality of members. The example of FIG. 8 presents a task flow that a member A and a member B carried out as a team from Aug. 1, 2011 to Aug. 5, 2011. In this example, a portion carried out by the member A is displayed by dashed lines, while a portion carried out by the member B is displayed by solid lines. In the flow, a portion being different from an expected task behavior flow is presented by encircling with an ellipse. In this way, tasks that are smoothly progressing and tasks with some problems can be easily distinguished and grasped in the task flow of the member A and the member B. It is noted that displaying a portion different from an expected task flow is not limited to a method of encircling with an ellipse, but for example, an icon itself may be color-coded, or an icon of the portion different from the expected task flow may flash.

In this way, by visually observing presentation information, a user can grasp a portion different from an expected task flow, and check a task state between members. Further, specifically, as is shown in FIG. 8, a fact that there is difference from the expected task flow, that is, a message indicating the task state, may be displayed in the presentation information. For example, in FIG. 8, a message “information is not promptly shared among members” is displayed at a portion where related task behavior of other members is not within 12 hours after “provision” of a mail and a file. In a flow of “use” “creation” “provision,” if task allocation is biased to the member B, a message “work is not carried out with workload being fairly allocated among members” is displayed.

Similar to FIG. 7, using icons that signify contents of task behavior such as a mail, a file, and a site, helps a user's understanding. Further, messages indicating task states are not limited to negative forms of sentences of the expected task patterns shown in FIG. 6, but may be more specific messages based on the basic behavior information, such as “sharing of information takes too much time,” “task allocation is biased to member B, and member A is not performing what member A is supposed to do.”

It is noted that the user terminal 7 may comprise an inputter that is configured by a keyboard, a mouse, or the like. Having the inputter allows the above-described input operation of the expected task flow to be performed by the user terminal 7.

It is noted that a user is, for example, a manager who controls a task state. Further, a member may control the task state as a user.

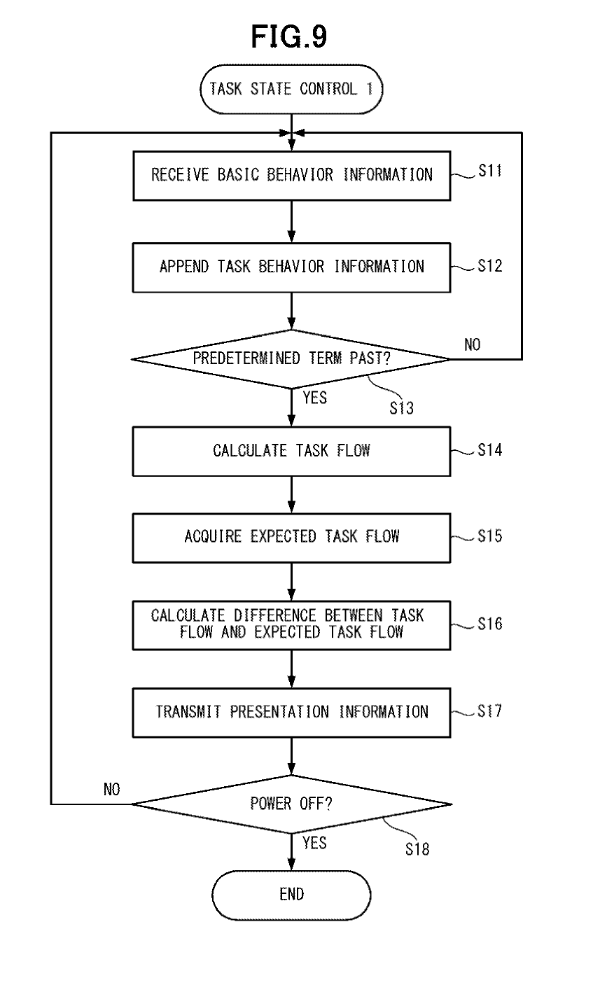

Next, operation of the task assistance system 100 that has the above-described configuration will be described with reference to a flowchart shown in FIG. 9. FIG. 9 is a flowchart showing an example of the operation of the task assistance system 100 according to the first embodiment.

First, the basic behavior information acquirer 11 of the task assistance device 1 receives basic behavior information from the behavior detection device 6 (Step S11). The basic behavior information acquirer 11 transmits the basic behavior information to the task behavior information appender 12. The task behavior information appender 12 refers to a correspondence table that correlates task behavior information and basic behavior information, and appends task behavior information to the basic behavior information received from the basic behavior information acquirer 11 (Step S12). The task behavior information appender 12 transmits the basic behavior information with the appended task behavior information to the task flow calculator 13.

Next, the task flow calculator 13 determines whether or not a predetermined term has passed (Step S13). If the task flow calculator 13 determines that the predetermined term has not passed yet (Step S13; NO), the processing returns to Step S11 and repeats Steps S11 to S13. Meanwhile, if the task flow calculator 13 determines that the predetermined term has passed (Step S13; YES), the task flow calculator 13 calculates a task flow, based on task behavior information that is appended to the basic behavior information received from the task behavior information appender 12 and attribute information of the basic behavior information (Step S14). Subsequently, the task flow calculator 13 transmits the task flow to the task flow difference detector 15.

Next, the expected task flow acquirer 14 acquires an expected task flow (Step S15), and transmits the acquired expected task flow to the task flow difference detector 15. The timing when the expected task flow acquirer 14 acquires the expected task flow and transmits the expected task flow to the task flow difference detector 15 may be anytime before Step S16.

The task flow difference detector 15 compares the task flow received from the task flow calculator 13 and the expected task flow received from the expected task flow acquirer 14, and detects difference between the task flow and the expected task flow (Step S16). Subsequently, the task flow difference detector 15 generates presentation information that indicates the detected difference, and transmits the presentation information to the user terminal 7 (Step S17). If a power supply of the task assistance device 1 is not turned OFF (Step S18; NO), the processing returns to Step S11 and repeats Steps S11 to S18. If the power supply of the task assistance device 1 is turned OFF (Step S18; YES), the processing ends.

As is described above, by the task assistance system 100 according to the first embodiment, whether or not behavior of a subject member is performed in accordance with a task flow that is supposed to be carried out can be grasped. Thus, a user can check a task state, and improve the task state by guiding the member. Further, as a member grasps the task state, members who are working on the same task can mutually know what kind of behavior other members are performing towards a goal which is to be collaboratively achieved, therefore, for example, the members can easily discuss appropriateness of an approaching method.

It is noted that, when the outputter 71 outputs the presentation information, a user may use the user terminal 7 to change the expected task flow. For example, when a user selects a task flow within a subject range of a display screen of the presentation information, an expected task flow change screen pops up and allows changing of the expected task flow. The user terminal 7 transmits the changed expected task flow to the expected task flow acquirer 14 of the task assistance device 1. In this way, an intention of a user formed as a result of checking an actual task state can be reflected in a task management, and thus, the task state can be expected to be improved.

### Second Embodiment

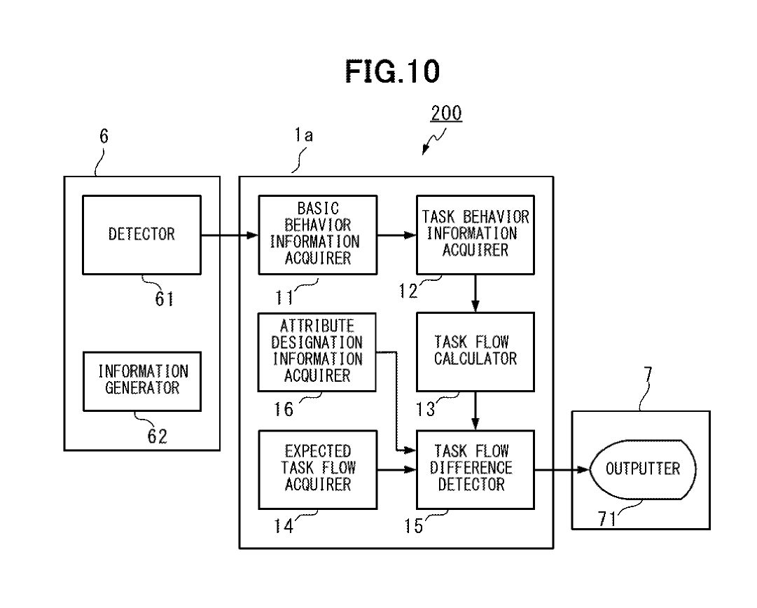

FIG. 10 is a block diagram showing a configuration example of a task assistance system according to a second embodiment of the present invention. The task assistance system 200 according to the second embodiment comprises a task assistance device 1a, a behavior detection device 6, and a user terminal 7. The behavior detection device 6 and the user terminal 7 are the same as those of the first embodiment. The task assistance device 1a comprises an attribute designation information acquirer 16 in addition to the configuration of the task assistance device 1 according to the first embodiment. It is noted that the same numerals and signs are assigned to portions overlapping the above-described first embodiment, and the description will be omitted.

The attribute designation information acquirer 16 acquires attribute designation information that indicates attribute information designated by a user from the outside. It is noted that the attribute designation information acquirer 16 may store attribute designation information in advance, or a user may directly input attribute designation information in the task assistance device 1a. Alternatively, the user terminal 7 may comprise an inputter, and the attribute designation information acquirer 16 may receive, from the user terminal 7, attribute designation information that a user inputs into the inputter. The attribute designation information acquirer 16 transmits the acquired attribute designation information to the task flow difference detector 15.

The task flow difference detector 15 narrows down to a task flow related to attribute information designated by the attribute designation information received from the attribute designation information acquirer 16, compares the task flow with an expected task flow, and detects difference.

Other operations of the task assistance system 200 are the same as those of the task assistance system 100, therefore, description will be omitted.

According to the second embodiment, for example, presentation information can be narrowed down when a user designates attribute information related to a project (for example, a file name including a project name) that the user speculates a task state to have a problem. This facilitates a user to find a problem. Alternatively, narrowing down presentation information by designating attribute information related to a member (for example, a file creator name, a mail sender name, or the like including a name of the member), facilitates finding a problem that the member has.

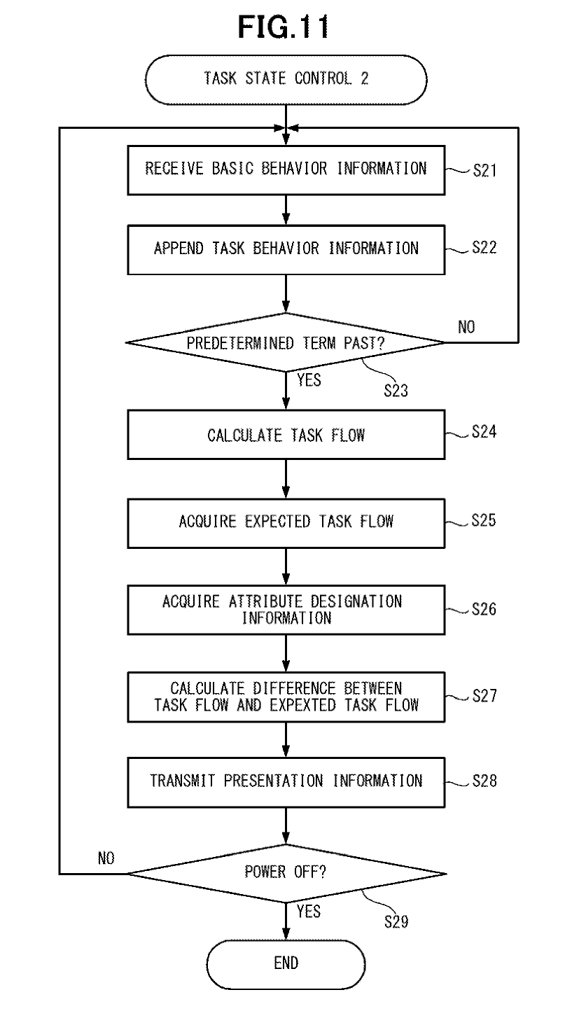

FIG. 11 is a flowchart showing an example of a task assistance operation according to the second embodiment.

First, the basic behavior information acquirer 11 of the task assistance device 1a receives basic behavior information from the behavior detection device 6 (Step S21). The basic behavior information acquirer 11 transmits the basic behavior information to the task behavior information appender 12. The task behavior information appender 12 refers to a correspondence table that correlates task behavior information and basic behavior information and appends task behavior information to the basic behavior information received from the basic behavior information acquirer 11 (Step S22). The task behavior information appender 12 transmits the basic behavior information with the appended task behavior information to the task flow calculator 13.

When a predetermined term has not passed (Step S23; NO), the processing returns to Step S21, and repeats Steps S21 to S23. When a predetermined term has passed (Step S23; YES), the task flow calculator 13 calculates a task flow in which the task behavior information that is appended to the basic behavior information received from the task behavior information appender 12 is interrelated based on attribute information of the basic behavior information (Step S24). The task flow calculator 13 transmits the task flow to the task flow difference detector 15.

The expected task flow acquirer 14 acquires an expected task flow (Step S25). The expected task flow acquirer 14 transmits the expected task flow to the task flow difference detector 15. The timing when the expected task flow acquirer 14 acquires the expected task flow and transmits the expected task flow to the task flow difference detector 15 may be anytime before Step S27.

The attribute designation information acquirer 16 acquires attribute designation information that indicates attribute information designated by a user (Step S26). The attribute designation information acquirer 16 transmits the attribute designation information to the task flow difference detector 15. The timing when the attribute designation information acquirer 16 acquires attribute designation information and transmits the attribute designation information to the task flow difference detector 15 may be anytime before Step S27.

The task flow difference detector 15 narrows down a task flow received from the task flow calculator 13 to a task flow related to attribute information designated by the attribute designation information received from the attribute designation information acquirer 16, compares with the expected task flow received from the expected task flow acquirer 14, and detects difference (Step S27).

The task flow difference detector 15 generates presentation information that indicates the detected difference and transmits the presentation information to the user terminal 7 (Step S28). If a power supply of the task assistance device 1a is not turned OFF (Step S29; NO), the processing returns to Step S21 and repeats Steps S21 to S29. If the power supply of the task assistance device 1a is turned OFF (Step S29; YES), the processing ends.

As is described above, by the task assistance system 200 according to the second embodiment, presentation result can be narrowed down, for example, for a task flow of tasks with high priority or a task flow that a user particularly wants to check. In this way, usability is improved, and a problem and a point to be improved are expected to be easily found out.

In the above-described embodiments, various items related to tasks, such as a Web site, an electronic file, an E-mail, and an area, are dealt with as an object of behavior of a member, but only an electronic file may be used as an object of behavior. In such a case, the behavior detection device 6 is a device that creates an electronic file, such as a PC or a mobile terminal. Examples of basic behavior information include information that indicates behavior of a member such as creating a file, browsing a file, and saving a file, and attribute information that is associated with the behavior and identifies an electronic file such as a file creator, a file browser, and file creation time and date. The task flow calculator 13 calculates, based on attribute information included in the basic behavior information, the task flow that interrelates task behavior information that the task flow calculator 13 determined as the same electronic file, among task behavior information that is appended to the basic behavior information.

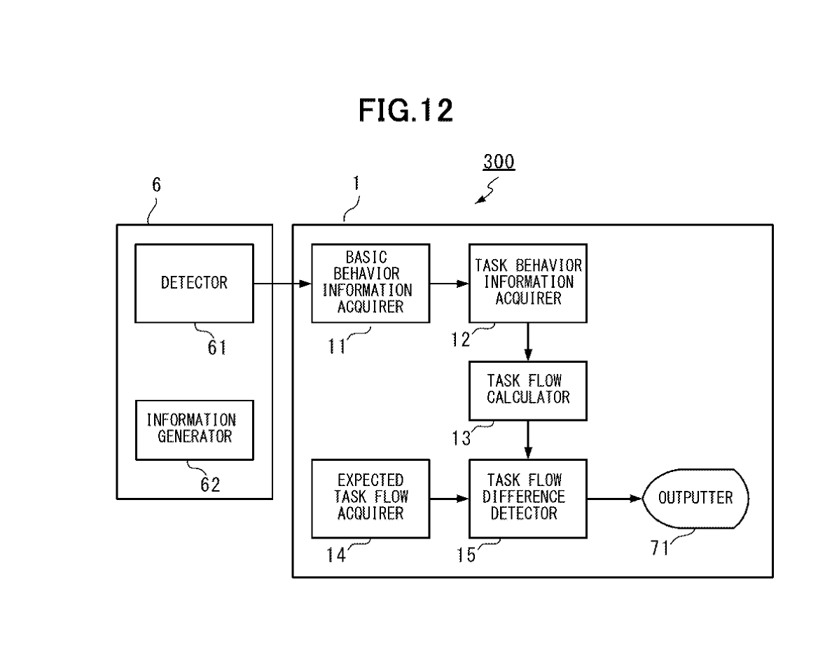

It is noted that in the task assistance systems according to the above described first and second embodiments, an example that the behavior detection device 6 and the user terminal 7 are configured separately from the task assistance device 1 is described, but it is not limited thereto. For example, as is described above, the user terminal may be integrally configured with the task assistance device (refer to FIG. 12). When the task assistance device 1b and the user terminal 7 are integrally formed, the task assistance device 1b in the task assistance system 300 includes the outputter 71.

[Hardware Configuration of the Task Assistance Device]

Next, a hardware configuration of the task assistance device according to the embodiments of the present invention will be described.

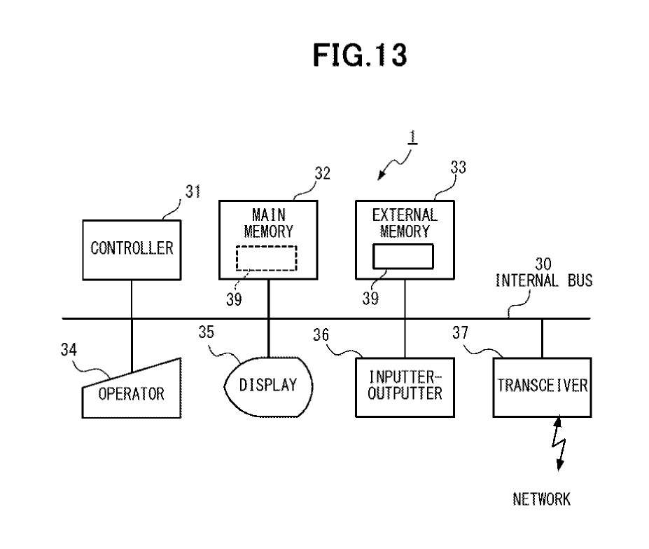

FIG. 13 is a block diagram showing an example of a hardware configuration of the task assistance device according to the embodiments of the present invention. As is shown in FIG. 13, the task assistance device 1 comprises a controller 31, a main memory 32, an external memory 33, an operator 34, a display 35, an inputter-outputter 36, and a transceiver 37. The main memory 32, the external memory 33, the operator 34, the display 35, the inputter-outputter 36, and the transceiver 37 are all connected to the controller 31 through an internal bus 30.

The controller 31 is configured by a Central Processing Unit (CPU) or the like, and executes each processing of the task behavior information appender 12, task flow calculator 13, and task flow difference detector 15 of the task assistance device 1 according to a control program 39 stored in the external memory 33.

The main memory 32 is configured by a Random-Access Memory (RAM) or the like, loads the control program 39 stored in the external memory 33, and is used as a work area of the controller 31.

The external memory 33 is configured by a non-volatile memory, such as a flash memory, a hard disc, a Digital Versatile Disc Random-Access Memory (DVD-RAM), and a Digital Versatile Disc ReWritable (DVD-RW). The external memory 33 stores in advance a program that causes the controller 31 to execute the processing of the task assistance device 1, moreover, provides data stored in the program for the controller 33 according to an instruction of the controller 31, and stores data provided by the controller 31.

The operator 34 is configured by a keyboard, a pointing device such as a mouse, and the like, and an interface device that connects the keyboard, the pointing device, and the like to the internal bus 30. When a user directly inputs information to the task assistance device 1, the input information is provided for the controller 31 via the operator 34.

The display 35 is configured by a Cathode Ray Tube (CRT), a Liquid Crystal Display (LCD), or the like. When a user directly inputs information to the task assistance device 1, the display 35 displays an operation screen. In a configuration of FIGS. 1 and 10 in which the user terminal 7 is included in the task assistance device 1, the display 35 may be the outputter 71.

The inputter-outputter 36 is configured either by a serial interface or a parallel interface. When the behavior detection device 6 and the user terminal 7 are attached to a device, the inputter-outputter 36 is connected thereto.

The transceiver 37 is configured by a network terminal device or a wireless communication device that is connected to a network, and a serial interface or a Local Area Network (LAN) interface connected thereto. The transceiver 37 is connected to the behavior detection device 6 and the user terminal 7 via the network. The transceiver 37 functions as the basic behavior information acquirer 11, the expected task flow acquirer 14, and the attribute designation information acquirer 16.

The processing of the basic behavior information acquirer 11, the task behavior information appender 12, the task flow calculator 13, the expected task flow acquirer 14, the task flow difference detector 15, and the attribute designation information acquirer 16 of the task assistance device 1 shown in FIG. 1 or 10 is executed when the control program 39 performs the processing using the controller 31, the main memory 32, the external memory 33, the operator 34, the display 35, the inputter-outputter 36, the transceiver 37, and the like, as resources.

It is noted that the above hardware configurations and the flowcharts are only examples, and can be arbitrarily changed or modified.

A portion that is a center of performing the task assistance processing, configured by the controller 31, the main memory 32, the external memory 33, the operator 34, the display 35, the inputter-outputter 36, the transceiver 37, the internal bus 30, and the like, can be realized using a general computer system, without using a dedicated system. For example, the task assistance device 1 that carries out the above processing may be configured by storing the computer program for executing the above operation in a computer-readable recording medium (a flexible disk, a CD-ROM, a DVD-ROM and the like), distributing, and installing the computer program in a computer. In addition, the task assistance device 1 may be configured by storing the computer program in a storage device included in a server device on a communication network such as the Internet, and causing a normal computer system to download the computer program or in other ways.

Further, when the functions of the task assistance device 1 are realized by sharing between an Operating System (OS) and an application program or by collaboration of the OS and the application program, only a portion of the application program may be stored in a recording medium or a storage device.

In addition, the computer program may be superimposed on a carrier wave so as to be delivered via a communication network. For example, the computer program may be posted on a bulletin board on a communication network (BBS; Bulletin Board System), and delivered via the network. Then, the computer program may be activated and executed in the same way as other application programs under control of the OS, thereby making it possible to perform the above processing.

The part or the whole of the above embodiments can be described as the following supplementary notes but it is not limited thereto.

(Supplementary Note 1)

A task assistance device comprising:

basic behavior information acquirer that acquires basic behavior information that indicates behavior of a subject member and includes attribute information associated with the behavior;

task behavior information appender that appends task behavior information that indicates a pre-set behavior classification to the basic behavior information;

task flow calculator that calculates a task flow that interrelates the task behavior information based on the attribute information included in the basic behavior information that the task behavior information is appended to;

expected task flow acquirer that acquires an expected task flow that indicates a task flow that the member is supposed to perform;

task flow difference detector that detects difference between the task flow calculated by the task flow calculator and the expected task flow acquired by the expected task flow acquirer; and

outputter that outputs presentation information that indicates difference between the task flow and the expected task flow.

(Supplementary Note 2)

The task assistance device according to Supplementary Note 1, further comprising:

attribute designation information acquirer that acquires attribute designation information that indicates the attribute information, wherein

the task flow difference detector narrows down to the task flow that is associated with the attribute information designated by the attribute designation information and calculates difference from the expected task flow.

(Supplementary Note 3)

The task assistance device according to Supplementary Note 1 or 2, wherein

the task flow difference detector changes an interval for detecting difference between the task flow and the expected task flow in accordance with a content of the expected task flow.

(Supplementary Note 4)

The task assistance device according to any one of Supplementary Notes 1 to 3, wherein

the task behavior information indicates a behavior classification of search, use, creation, and provision.

(Supplementary Note 5)

The task assistance device according to any one of Supplementary Notes 1 to 4, wherein

an object of behavior of the member is an electronic file;

the attribute information is information that identifies an electronic file for the object of behavior; and

the task flow calculator calculates the task flow that interrelates the task behavior information that is appended to the basic behavior information that includes the same electronic file for the object of behavior.

(Supplementary Note 6)

A task assistance system comprising:

a behavior detection device that includes detector that detects behavior of a subject member;

a task assistance device that includes:

basic behavior information acquirer that acquires basic behavior information that indicates behavior of the member and includes attribute information associated with the behavior, from the behavior detection device;

task behavior information appender that appends task behavior information that indicates a pre-set behavior classification, to the basic behavior information;

task flow calculator that calculates a task flow that interrelates the task behavior information based on the attribute information included in the basic behavior information that the task behavior information is appended to;

expected task flow acquirer that acquires an expected task flow that indicates a task flow that the member is supposed to perform; and

task flow difference detector that detects difference between the task flow calculated by the task flow calculator and the expected task flow acquired by the expected task flow acquirer; and

a user terminal that includes outputter that outputs presentation information that indicates difference between the task flow and the expected task flow.

(Supplementary Note 7)

A task assistance method comprising:

a detection step of detecting behavior of a subject member, carried out by a behavior detection device;

a basic behavior information acquisition step of acquiring basic behavior information that indicates behavior of the member and includes attribute information associated with the behavior, from the behavior detection device, carried out by a task assistance device;

a task behavior information appending step of appending task behavior information that indicates a pre-set behavior classification, to the basic behavior information;

a task flow calculation step of calculating a task flow that interrelates the task behavior information based on the attribute information included in the basic behavior information that the task behavior information is appended to;

an expected task flow acquisition step of acquiring an expected task flow that indicates a task flow that the member is supposed to perform;

a task flow difference detection step of detecting difference between the task flow calculated in the task flow calculation step and the expected task flow acquired in the expected task flow acquisition step; and

an output step of outputting presentation information that indicates difference between the task flow and the expected task flow that is detected in the task flow difference detection step.

(Supplementary Note 8)

The task assistance method according to Supplementary Note 7, further comprising:

an attribute designation information acquisition step of acquiring attribute designation information that indicates the attribute information, wherein

the task flow difference detection step comprises narrowing down to the task flow that is associated with the attribute information designated by the attribute designation information and calculating difference from the expected task flow.

(Supplementary Note 9)

The task assistance method according to Supplementary Note 7 or 8, wherein

the task flow difference detection step comprises changing an interval for detecting difference between the task flow and the expected task flow in accordance with a content of the expected task flow.

(Supplementary Note 10)

The task assistance method according to any one of Supplementary Notes 7 to 9, wherein

the task behavior information indicates a behavior classification of search, use, creation, and provision.

(Supplementary Note 11)

The task assistance method according to any one of Supplementary Notes 7 to 10, wherein

an object of behavior of the member is an electronic file;

the attribute information is information that identifies an electronic file for the object of behavior; and

the task flow calculation step comprises calculating the task flow that interrelates the task behavior information that is appended to the basic behavior information that includes the same electronic file for the object of behavior.

(Supplementary Note 12)

A storage medium that stores a program that causes a computer to function as:

basic behavior information acquirer that acquires basic behavior information that indicates behavior of a subject member and includes attribute information associated with the behavior;

task behavior information appender that appends task behavior information that indicates a pre-set behavior classification, to the basic behavior information;

task flow calculator that calculates a task flow that interrelates the task behavior information based on the attribute information included in the basic behavior information that the task behavior information is appended to;

expected task flow acquirer that acquires an expected task flow that indicates a task flow that the member is supposed to perform;

task flow difference detector that detects difference between the task flow calculated by the task flow calculator and the expected task flow acquired by the expected task flow acquirer; and

outputter that outputs presentation information that indicates difference between the task flow and the expected task flow.

It is noted that the present invention can be applied to a variety of embodiments and modifications without departing from the broad spirit and scope of the present invention. Moreover, the embodiments described above are only for the description of the present invention, and do not restrict the scope of the present invention. In other words, the scope of the present invention is indicated not by the embodiments but by the appended claims. Thus, a variety of modifications that are made within the scope of the claims and the scope of the significance of the invention equivalent to the claims, fall within the scope of the present invention.

The present invention is based on Japanese Patent Application No. 2011-228769 filed as of Oct. 18, 2011. The present specification includes, as reference, the whole specification, claims, and the drawings of Japanese Patent Application No. 2011-228769.

### REFERENCE SIGNS LIST

1, 1a, 1b Task assistance device
6 Behavior detection device
7 User terminal
11 Basic behavior information acquirer
12 Task behavior information appender
13 Task flow calculator
14 Expected task flow acquirer
15 Task flow difference detector
16 Attribute designation information acquirer
30 Internal bus
31 Controller
32 Main memory
33 External memory
34 Operator
35 Display
36 Inputter-outputter
37 Transceiver
39 Control program
61 Detector
62 Information generator
71 Outputter
100, 200, 300 Task assistance system

1. A task assistance device comprising:
basic behavior information acquirer that acquires basic behavior information that indicates behavior of a subject member and includes attribute information associated with the behavior;
task behavior information appender that appends task behavior information that indicates a pre-set behavior classification to the basic behavior information;
task flow calculator that calculates a task flow that interrelates the task behavior information based on the attribute information included in the basic behavior information that the task behavior information is appended to;
expected task flow acquirer that acquires an expected task flow that indicates a task flow that the member is supposed to perform;
task flow difference detector that detects difference between the task flow calculated by the task flow calculator and the expected task flow acquired by the expected task flow acquirer; and
outputter that outputs presentation information that indicates difference between the task flow and the expected task flow.

2. The task assistance device according to claim 1, further comprising:
attribute designation information acquirer that acquires attribute designation information that indicates the attribute information, wherein
the task flow difference detector narrows down to the task flow that is associated with the attribute information designated by the attribute designation information and calculates difference from the expected task flow.

3. The task assistance device according to claim 1, wherein
the task flow difference detector changes an interval for detecting difference between the task flow and the expected task flow in accordance with a content of the expected task flow.

4. The task assistance device according to claim 1, wherein
the task behavior information indicates a behavior classification of search, use, creation, and provision.

5. The task assistance device according to claim 1, wherein
an object of behavior of the member is an electronic file;
the attribute information is information that identifies an electronic file for the object of behavior; and
the task flow calculator calculates the task flow that interrelates the task behavior information that is appended to the basic behavior information that includes the same electronic file for the target of behavior.

6. A task assistance system comprising:
a behavior detection device that includes detector that detects behavior of a subject member;
a task assistance device that includes:
basic behavior information acquirer that acquires basic behavior information that indicates behavior of the member and includes attribute information associated with the behavior, from the behavior detection device;
task behavior information appender that appends task behavior information that indicates a pre-set behavior classification, to the basic behavior information;
task flow calculator that calculates a task flow that interrelates the task behavior information based on the attribute information included in the basic behavior information that the task behavior information is appended to;
expected task flow acquirer that acquires an expected task flow that indicates a task flow that the member is supposed to perform; and
task flow difference detector that detects difference between the task flow calculated by the task flow calculator and the expected task flow acquired by the expected task flow acquirer; and
a user terminal that includes outputter that outputs presentation information that indicates difference between the task flow and the expected task flow.

7. A task assistance method comprising:
a detection step of detecting behavior of a subject member, carried out by a behavior detection device;
a basic behavior information acquisition step of acquiring basic behavior information that indicates behavior of the member and includes attribute information associated with the behavior, from the behavior detection device, carried out by a task assistance device;
a task behavior information appending step of appending task behavior information that indicates a pre-set behavior classification to the basic behavior information;
a task flow calculation step of calculating a task flow that interrelates the task behavior information based on the attribute information included in the basic behavior information that the task behavior information is appended to;
an expected task flow acquisition step of acquiring an expected task flow that indicates a task flow that the member is supposed to perform;
a task flow difference detection step of detecting difference between the task flow calculated in the task flow calculation step and the expected task flow acquired in the expected task flow acquisition step; and
an output step of outputting presentation information that indicates difference between the task flow and the expected task flow that is detected in the task flow difference detection step.

8. The task assistance method according to claim 7, further comprising:
an attribute designation information acquisition step of acquiring attribute designation information that indicates the attribute information, wherein
the task flow difference detection step comprises narrowing down to the task flow that is associated with the attribute information designated by the attribute designation information and calculating difference from the expected task flow.

9. The task assistance method according to claim 7, wherein
the task flow difference detection step comprises changing an interval for detecting difference between the task flow and the expected task flow in accordance with a content of the expected task flow.

10. A storage medium that stores a program that causes a computer to function as:
basic behavior information acquirer that acquires basic behavior information that indicates behavior of a subject member and includes attribute information associated with the behavior;
task behavior information appender that appends task behavior information that indicates a pre-set behavior classification, to the basic behavior information;
task flow calculator that calculates a task flow that interrelates the task behavior information based on the attribute information included in the basic behavior information that the task behavior information is appended to;
expected task flow acquirer that acquires an expected task flow that indicates a task flow that the member is supposed to perform;
task flow difference detector that detects difference between the task flow calculated by the task flow calculator and the expected task flow acquired by the expected task flow acquirer; and
outputter that outputs presentation information that indicates difference between the task flow and the expected task flow.
